(19) United States
(12) Patent Application Publication
(10) Pub. No.: US 2001/0021973 A1
(43) Pub. Date: Sep. 13, 2001

(54) Processor

(75) Inventors: Junya Yamashita, Kyoto (JP); Yushi Tamura, Hyogo (JP); Takeharu Yamamoto, Osaka (JP); Yoshihiro Kanda, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 09/802,952

(22) Filed: Mar. 12, 2001

(30) Foreign Application Priority Data
Mar. 10, 2000 (JP) 2000-066496

(51) Int. Cl. G06F 9/00

(52) U.S. Cl. 712/239

(57) ABSTRACT

In order to achieve a processor that does not require processing time for branching processing and is ensured the flexibility of the processing content, an adder adds a start address stored in start address parts and selected by a selector and a stored content (relative address) of a program counter to output a current execution instruction address. An execution unit executes an instruction of the address of a program storing part. A comparator compares the address with an end address stored in end address storing parts and selected by a selector. When the addresses are matched, the selectors are switched, and the program counter is reset, so that branching can be performed without requiring an instruction cycle. The start address storing parts are rewritten by a supervisory processor, where appropriate.

### BACKGROUND OF THE INVENTION

The present invention relates to a processor for executing instructions stored in a memory. In particular, the present invention relates to high speed branching processing of shifting control to an instruction stored in a noncontinuous address area in a memory.

In general, a processor fetches and executes an instruction stored in an address area shown by a program counter in a memory. The address stored in the program counter is automatically counted up by an operation of hardware with an operation of fetching an instruction. Thus, instructions stored in a continuous address area in a memory are sequentially executed. On the other hand, branching processing of shifting the control to an instruction stored in a noncontinuous address area in accordance with predetermined conditions or under no conditions is performed by rewriting the address stored in the program counter by software (execution of a branching instruction). In other words, an instruction cycle of a branching instruction occurs for each branching processing, and this requires one or more clock cycles.

In the field of equipment control or the like, several relatively short program modules (processes) are repeated in many cases. More specifically, for example, in the case where servo control is performed, it is necessary to monitor the control amount and to control the operation amount at high speed repeatedly. In addition, since it is necessary to vary the control content, depending on whether or not the control amount exceeds a predetermined threshold, for example, some of ten and several kinds of program modules, each of which has about ten and several steps, are selectively repeated while the processing order is changed as appropriate. In other words, it is attempted to achieve high speed and flexibility of control processing by creating small units of modules for a program.

However, when relatively short program modules are executed repeatedly, a branching instruction is executed at least once for each program module processing. Therefore, the ratio of the execution time of the branching instruction to the whole processing time of the program modules becomes large, so that the total processing time tends to become long. Thus, a conventional processor cannot be used in control systems that are required to operate in a particularly high speed.

### SUMMARY OF THE INVENTION

In view of the above-mentioned conventional problems, it is an object of the present invention to provide a processor that can prevent an increase of processing time due to branching processing and can change the processing content flexibly in accordance with various conditions, even if the processor sequentially executes a plurality of program modules selectively.

A processor of the present invention includes instruction executing means for executing an instruction stored in storing means; and execution instruction address outputting means for outputting an execution instruction address that is an address of an area in which an instruction to be executed by the instruction executing means is stored; the processor further including detecting means for detecting that the instruction to be executed by the instruction executing means is the last instruction of a process before branching, wherein the execution instruction address outputting means outputs a start address that is an address of an area in the storing means in which the first instruction of a process after branching is stored, when the last instruction is detected by the detecting means.

According to the above embodiment, when the last instruction is detected by the detecting means, since the start address of a process after branching is output by the execution instruction address outputting means, following the execution of the last instruction before branching, the first instruction after branching can be executed without an instruction cycle for a executing an branching instruction by the instruction executing means. Therefore, processes that require branching can be processed at high speed, and the total processing time can be reduced.

More specifically, for example, the execution instruction address outputting means may include start address storing means for storing a start address of each of a plurality of processes in the storing means; start address selecting means for sequentially switching and selecting the start address stored in the start address storing means, every time the last instruction is detected by the detecting means, wherein the execution instruction address is output based on the start address selected by the start address selecting means.

This makes it easy, for example, for the processor to repeat processing by sequentially switching a plurality of processes, and an increase in the processing time due to branching processing at the time of switching can be suppressed.

In order for the detecting means to detect the last instruction, the processor may further include end address storing means for storing an end address that is an address of an area in which the last instruction of each of a plurality of processes is stored in the storing means; end address selecting means for sequentially switching and selecting the end address stored in the end address storing means, every time the last instruction is detected by the detecting means, wherein the detecting means detects the last instruction based on the execution instruction address output from the execution instruction address outputting means and the end address selected by the end address selecting means.

This makes it easy to sequentially detect the last instruction of each process, for example, when the processor repeats processing by sequentially switching a plurality of processes.

Furthermore, instead of the end address storing means and the selecting means as described above, the processor may further include processing length storing means for storing a processing length that is a relative address of an end address to a start address of each of a plurality of processes in the storing means; processing length selecting means for sequentially switching and selecting the processing length stored in the processing length storing means, every time the last instruction is detected by the detecting means, wherein the execution instruction address outputting means adds a start address of a process under processing and a relative address of the execution instruction address to the start address to generate the execution instruction address, and the detecting means detects the last instruction based on the relative address and the processing length selected by the processing length selecting means.

This makes it possible to detect the last instruction of each process for example, when the processor repeats processing by sequentially switching a plurality of processes. Moreover, since the processing length, which is a relative address, has a smaller data amount (a smaller number of bits) than that of the end address, which is an absolute address, a hardware scale of the processing length storing means, the processing length selecting means and the detecting means can be small.

Furthermore, as another embodiment in which the detecting means detects the last instruction, the detecting means may detect the last instruction based on information indicating the last instruction stored in correspondence with information indicating a content of an instruction to be executed by the instruction executing means in the storing means.

This makes it possible to detect the last instruction without the end address storing means or the processing length storing means, so that a hardware scale can be small.

Furthermore, the start address storing means, the end address storing means or the processing length storing means may include a plurality of registers each of which stores the start address, etc., and the start address selecting means, the end address selecting means, or the processing length selecting means includes a selector for selecting one of the plurality of registers.

This makes it easy to configure the start address storing means or the start address selecting means or the like, and store or output the start addresses, etc. easily.

Furthermore, the start address storing means, the end address storing means or the processing length storing means may include a memory storing the start address, etc., and the start address selecting means, the end address storing means or the processing length storing means may include address designating means for designating an address of an area in which the start address, etc., are stored in the memory.

This makes it possible to configure the start address storing means, etc., using a part of a memory storing programs or data (used for multiple purposes) so that a hardware scale can be small.

Furthermore, the start address, etc. stored in the start address storing means, the end address storing means or the processing length storing means can be set by execution of an instruction by the instruction executing means or a supervisory processor for controlling the operation of the processor.

This makes it possible to control the process to be processed after branching by the execution of an instruction by the instruction executing means or the operation of the supervisory processor, so that the processing content can be changed flexibly in accordance with various conditions. In the case where the process includes an instruction to set the start address, etc., as described above, with respect to that process, an instruction cycle for executing that instruction occurs. However, the process that does not include such an instruction, high speed processing is performed as above, so that the total processing time can be reduced.

Furthermore, when the start address, etc. can be set by a supervisory processor, the processor may further include start address storing means for the supervisory processor for storing a start address output from the supervisory processor, end address storing means for the supervisory processor, or processing length storing means for the supervisory processor, wherein the start address, etc. stored in the start address storing means for the supervisory processor, etc. is written in the start address storing means, etc. at a predetermined timing.

By providing the start address storing means for the supervisory processor, etc. as described above, at the time when the start address is stored in such storing means, the process under processing is not affected, so that the start address can be stored in the start address storing means for the supervisory processor at an arbitrary timing. Furthermore, rewriting the start address stored in the start address storing means, etc. is performed at a predetermined timing, so that the process to be processed after branching can be controlled appropriately. Herein, the predetermined timing is a timing, for example, at which the start address, etc. stored in the start address storing means, etc. is not used in the process under processing. More specifically, the timing is a time after detection of the last instruction, or during processing of another process. Rewriting the start address, etc. at such timing does not affect detection of the last instruction or process. Therefore, control of appropriate process can be ensured, and the timing at which the supervisory processor sets the start address, etc. can be flexible, so that waiting or interruption does not occur in the supervisory processor. Thus, the processing of the supervisory processor can be simplified and the processing efficiency can be improved.

This and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a configuration of a processor of Example 1 of the present invention.

FIG. 2 is a flowchart showing an operation of the processor of Example 1.

FIG. 3 is a diagram for illustrating an example of a stored state of a program module that is processed by the processor.

FIG. 4 is a diagram for illustrating an example of storage content of an address storage device 100 of the processor of Example 1.

FIG. 5 is a diagram for illustrating another example of storage content of an address storage device 100 of the processor of Example 1.

FIG. 6 is a block diagram showing a configuration of a processor of Example 2 of the present invention.

FIG. 7 is a flowchart showing an operation of the processor of Example 2.

FIG. 8 is a block diagram showing a configuration of a processor of Example 3 of the present invention.

FIG. 9 is a diagram for illustrating an example of writing timing of start/end addresses of the processor of Example 3.

FIG. 10 is a block diagram showing a configuration of a processor of Example 4 of the present invention.

FIG. 11 is a flowchart showing an operation of the processor of Example 4.

### DETAILED DESCRIPTION OF THE INVENTION

### EXAMPLE 1

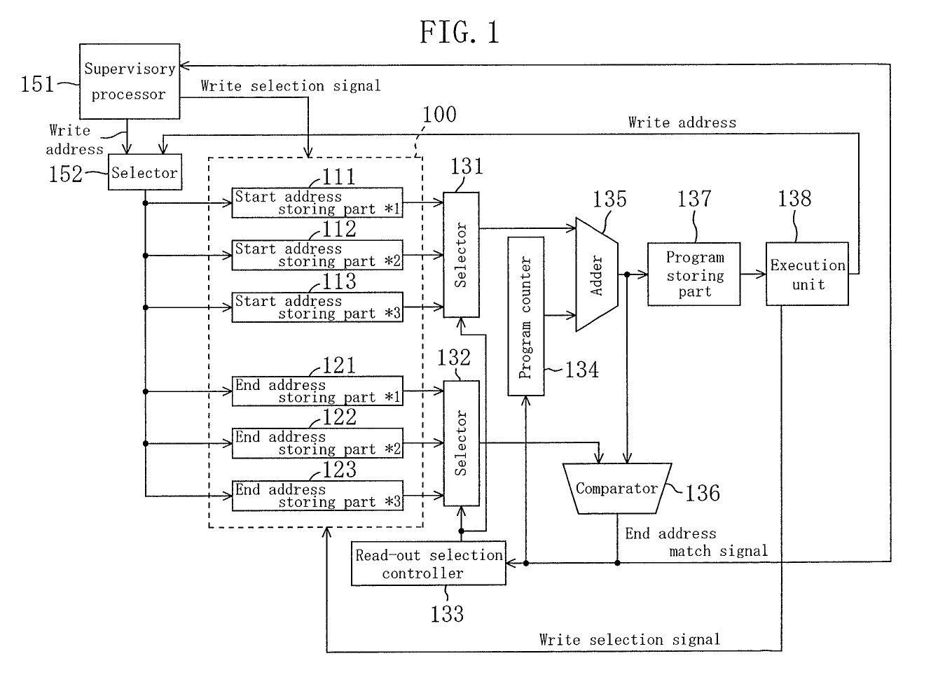

A processor of Example 1 of the present invention shifts the control to the next program module, when an address of an executing instruction in a program module (process) under processing is matched with an end address of the program module (hereinafter, referred to as “current execution instruction address”). Both the addresses are absolute addresses. Thus, branching can be performed without executing a branching instruction, so that high speed processing is possible. Furthermore, as for the next program module, the combination and the processing order of the program modules to be processed can be controlled flexibly by management (or determination) of a supervisory processor. This example will be described more specifically with reference to FIG. 1 below.

FIG. 1 is a block diagram showing a configuration of the processor. In FIG. 1, an address storage device 100 stores a start address and an end address (both of which are absolute addresses) of each program module to be processed. More specifically, this address storage device 100 includes start address storing parts 111 to 113 (start address storing means) for storing start addresses and end address storing parts 121 to 123 (end address storing means) for storing end addresses corresponding to the start address storing parts 111 to 113. More specifically, the address storing parts 111 to 113 and 121 to 123 can be configured with, for example a register, or can be configured with a memory as described later (Example 4).

A selector 131 (start address selecting means) selects and outputs an start address that is stored in one of the start address storing parts 111 to 113.

A selector 132 (end address selecting means) selects and outputs an end address that is stored in one of the end address storing parts 121 to 123.

A read-out selection controller 133 outputs a read-out selection signal indicating which start address and which end address in the address storing parts 111 to 113 and 121 to 123 should be selected and read out to the selectors 131 and 132. More specifically, the read-out selection controller 133, is configured with, for example, a ring counter, and outputs a read-out selection signal to the selectors 131 and 132 so that the start address storing parts 111 to 113 and the end address storing parts 121 to 123 are selected in the order of *1→ *2 →*3 →*1 →*2 →*3 →*1→. . . , every time an end address match signal is output from a comparing part 136, as described later.

A program counter 134 stores a relative address of an instruction to be executed with respect to the start address of the program module that is under processing. The stored relative address is counted up for each clock cycle and is reset to 0 when an end address match signal is output from the comparing part 136.

An adder 135 adds a start address of the program module under processing output by selection of the selector 131 and a relative address output from the program counter 134 to output a current execution instruction address (absolute address) (the start address storing part 111 to 113, the selector 131, the program counter 134 and the adder 135 act as instruction address output means).

A comparator 136 (detecting means) compares the current execution instruction address output from the adder 135 with an end address of the program module under processing output by selection of the selector 132. Then, the comparator 136 outputs an end address match signal to the read-out selection controller 133, the program counter 134 and the supervisory processor 151, when the addresses are matched (or a match is detected).

A program storing part 137 (storing means) stores program modules to be processed, and outputs an instruction to be executed in response to the absolute address output from the adder 135.

An execution unit 138 (instruction executing means) executes various instructions output from the program storing part 137. The execution unit 138 also can execute an instruction to rewrite the stored content (start address and end address) of the address storing part 111 to 113 and 121 to 123 (hereinafter, referred to as “rewrite instruction”). When the rewrite instruction is executed, the execution unit 138 outputs a write selection signal to the address storage device 100, and outputs a write address to the address storage device 100 via a selector 152 as described later. The write selection signal indicates which of the address storing part 111 to 113 and 121 to 123 to write an address in. Thus, the start address and the end address stored in the address storage device 100 can be rewritten, so that when processing of a program module ends, the next program module to be processed can be changed flexibly. The execution unit 138 may execute a conditional branching instruction or an unconditional branching instruction to rewrite the values stored in the program counter 134 as in an ordinary processor.

A supervisory processor 151 controls the entire system including the processor. Regarding the branching control of the processor, the supervisory processor 151 outputs a write selection signal to the address storage device 100, and outputs a write address to the address storage device 100 via a selector 152. Thus, the start address and the end address stored in the address storage device 100 can be rewritten, so that the next program module to be processed when processing of a program module ends can be changed flexibly. In addition, in the case where the start address and the end address are rewritten by the supervisory processor 151, an instruction cycle for an execution of the execution unit 138 is not required, so that the processor can process the program modules in a high speed. It should be noted that on principle, it is not permitted to rewrite the start address and the end address of the program module under processing. Therefore, an end address match signal is input from the comparator 136 to the supervisory processor 151, and the supervisory processor 151 rewrites the address by interruption processing at the timing at which the end address match signal is input. Instead of the interruption processing, the address can be rewritten in the following manner. A register is provided so that a flag indicating that it is permitted to rewrite the address (namely, the program module is not under processing) is set in response to the end address match signal output from the comparator 136. The supervisory processor 151 monitors the flag at a predetermined timing, and when the flag is set, the address is rewritten.

The selector 152 selects a write address output from the execution unit 138 or the supervisory processor 151 and outputs the write address to the address storage device 100.

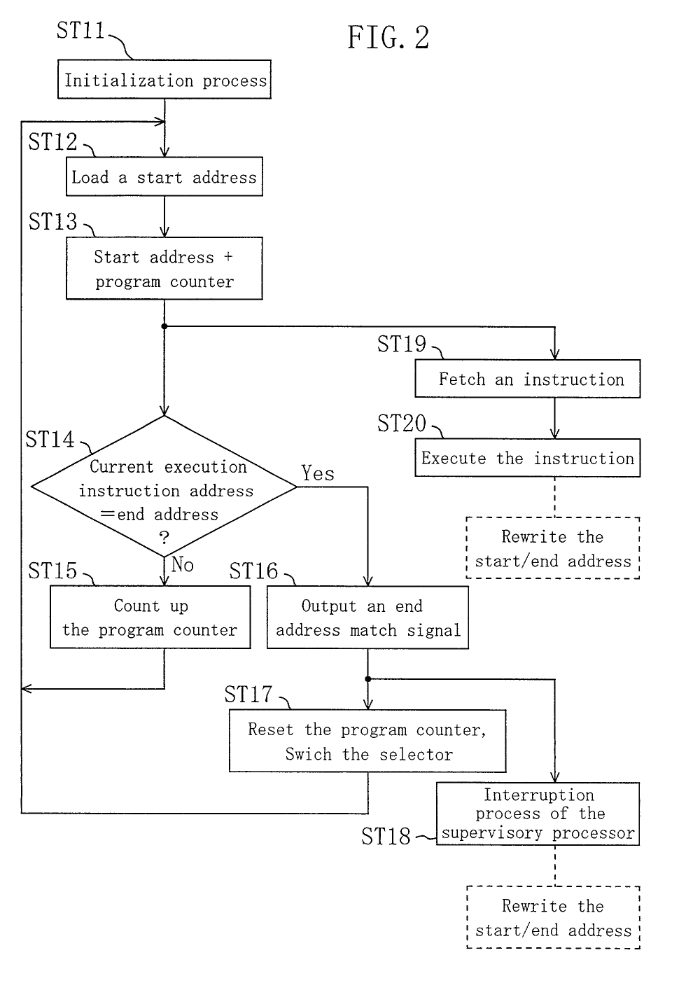

Next, the operation of the processor configured as above will be described with reference to FIG. 2. FIG. 2 is a flowchart showing the operation of the processor.

(Step ST11) First, when the first program module processing is started, the address storage device 100, the read-out selection part 133 and the program counter 134 are initialized, for example, by the control of the supervisory processor 151. More specifically, the start address and the end address of each program module to be processed sequentially are stored in the address storage device 100. The read-out selection controller 133 is set so that the selectors 131 and 132 select the start address storing part 111 and the end address storing part 121 that store the start address and the end address of the first program module to be processed, respectively. Furthermore, the program counter 134 is reset to 0.

(Step ST12) The start address stored in one of the start address storing parts 111 to 113 selected by the selector 131 and the relative address stored in the program counter 134 are loaded in the adder 135.

(Step ST13) The adder 135 adds the loaded start address and the loaded relative address, and outputs an obtained current execution instruction address to the comparator 136 and the program storing part 137. Thereafter, the processes after the step ST14 (performed by the comparator 136 and the like) and the processes after the step ST19 (performed by the execution unit 138) are performed in parallel.

(Step ST14) The comparator 136 compares the current execution instruction address output from the adder 135 and the end address stored in one of the end address storing parts 121 to 123 selected by the selector 132.

(Step ST15) When the current execution instruction address is not matched with the end address in the step ST14, the program counter 134 is counted up and the processes after the step ST12 are repeated.

(step ST16) On the other hand, when the current execution instruction address is matched with the end address in the step ST14, the comparator 136 outputs an end address match signal to the read-out selection controller 133, the program counter 134 and the supervisory processor 151.

(Step ST17) When the end address match signal is input to the read-out selection controller 133, the read-out selection controller 133 outputs a read-out selection signal for selecting one of the address storing parts 111 to 113 and one of the address storing parts 121 to 123 that stores the start address and the end address of the next program module to be processed to the selectors 131 and 132, respectively. When the end address match signal is input to the program counter 134, the program counter 134 is reset to 0. Thereafter, the processes after the step ST12 are repeated. Thus, at the time of executing the last instruction of a program module, regardless of the content of the instruction, the selection of the address storing parts 111 to 113 and 121 to 123 is automatically switched. Therefore, an instruction cycle for branching is not required, and in the next instruction cycle, the instruction of the next program module can be executed.

(Step ST18) When the end address match signal is input as an interruption signal to the supervisory processor 151, the supervisory processor 151 determines whether or not it is necessary to rewrite the start address and the end address. If it is necessary, a write selection signal indicating which of the address storing parts 111 to 113 and 121 to 123 to write an address in is output to the address storage device 100, and a write address is output to the address storage device 100 via the selector 152. Thus, the program module to be processed immediately after that or when the current execution instruction address is matched with the end address later can be changed flexibly. Herein, the determination whether or not it is necessary to rewrite the address can be performed based on execution results of an instruction by the processor 138, the status of each part of the system including the processor, which program module is under processing, or which address storing part of the address storing parts 111 to 113 and 121 to 123 stores the start/end address of the program module under processing (the address storing parts 111 to 113 and 121 to 123 selected by the selectors 131 and 132).

(Step ST19) On the other hand, when the current execution instruction address output from the adder 135 is input to the program storing part 137 in the step ST13, an instruction stored in the area of that address is fetched by the execution unit 138.

(Step ST20) The execution unit 138 executes the fetched instruction. Here, when the instruction to be executed is a rewrite instruction to rewrite the stored content of the address storing parts 111 to 113 and 121 to 123, the execution unit 138 outputs a write selection signal indicating which of the address storing parts 111 to 113 and 121 to 123 to write an address in to the address storage device 100, and outputs a write address to the address storage device 100 via the selector 152. In this case, the program module to be processed can be changed flexibly without depending on the supervisory processor 151.

Next, specific storage content and the like of the address storage device 100 for the above-described operation will be described below.

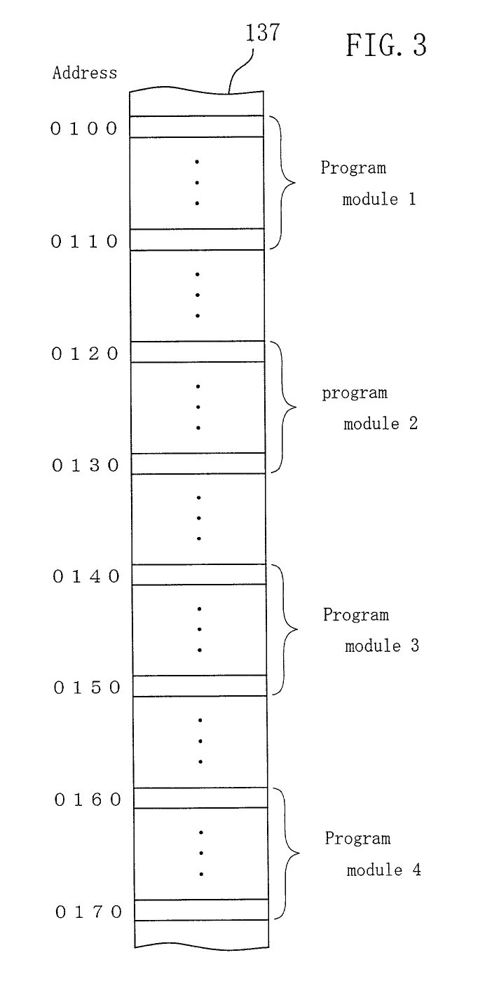

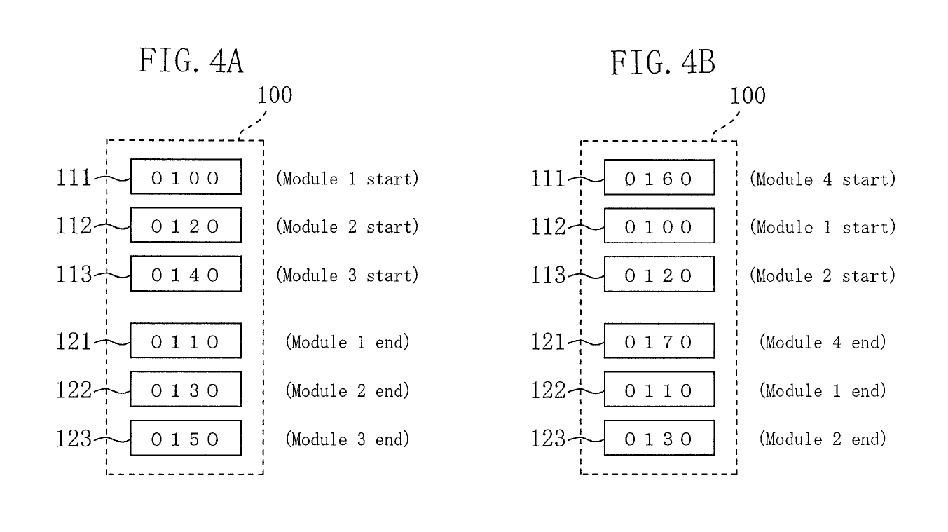

(1) For example, as shown in FIG. 3, four program modules 1, 2, 3 and 4 are stored in areas having addresses (0100 to 0110), (0120 to 0130), . . . (hexadecimal notation) in the program storing part 137, and these program modules are sequentially processed repeatedly. In this case, in the initialization process (step ST11), the start/end addresses of the program modules 1 to 3 are stored in the address storing part 111 to 113 and 121 to 123 of the address storage device 100 as shown in FIG. 4A. The read-out selection controller 133 sets, for example in such a manner that the selectors 131 and 132 select the address storing part 111 and 121.

(2) In the first instruction cycle, the adder 135 adds the start address (0100) of the program module 1 output from the start address storing part 111 selected by the selector 131 and the relative address (0000) output from the program counter 134, and outputs the addition result of an absolute address (0100) to the program storing part 137. There, an instruction stored in the area of the absolute address (0100) in the program storing part 137 is fetched and executed by the execution unit 138. At this time, since the end address stored in the end address storing part 121 is (0110), an end address match signal is not output from the comparator 136, and the relative address stored in the program counter 134 is counted up, for example, to (0101).

(3) In the next instruction cycle, as in the process of (2), an instruction in the area of the absolute address (0101) output from the adder 135 in the program storing part 137 is executed by the execution unit 138, and the relative address stored in the program counter 134 is further counted up.

(4) Thereafter, the same operation is performed, and when the relative address stored in the program counter 134 becomes (0010), the absolute address output from the adder 135 becomes (0110), and the instruction corresponding thereto is executed by the execution unit 138. At the same time, since the absolute address is matched with the end address stored in the end address storing part 121, an end address match signal is output from the comparator 136 to the read-out selection controller 133, the program counter 134, and the supervisory processor 151. Then, the selectors 131 and 132 are switched to select the start address storing part 112 and the end address storing part 122, respectively. The program counter 134 is reset.

(5) Then, in the next instruction cycles and after that, instructions in an area of an absolute address (0120) and the subsequent addresses (the program module 2) in the program storing part 137 are executed.

(6) The same operation is repeated, and at the time of executing the last instruction of the program module 3 stored in the area of an absolute address (0150) in the program storing part 137, the selectors 131 and 132 are switched to select the start address storing part 111 and the end address storing part 121 again, respectively. The program counter 134 is reset. At this time, the supervisory processor 151 rewrites the stored content of the address storing parts 111 to 113 and 121 to 123 as shown in FIG. 4B in response to the end address match signal input from the comparator 136 (Rewriting the address storing parts 111 and 121 and the address storing parts 112 and 122 can be performed after the processing of the program modules 1 and 2 ends, respectively, and before the processing of the program module 3 ends). In the next instruction cycle, the processing of the program module 4 is started. Thereafter, in the same manner, switching selection of the selectors 131 and 132 and rewriting the address storage device 100 are performed, so that the processing of the program modules 1 to 4 is sequentially performed repeatedly.

Another method of repeated processing for the program modules 1 to 4 is that the address storage device 100 is rewritten by the execution unit 138 executing a rewrite instruction, instead of control of the supervisory processor 151. More specifically, for example, a rewrite instruction is executed during processing of each program module, so that the start/end addresses of the next program to be processed are stored in the address storing parts 111 to 113 and 121 to 123 to be selected next by the selectors 131 and 132. Thus, the processing of each program module can be sequentially performed.

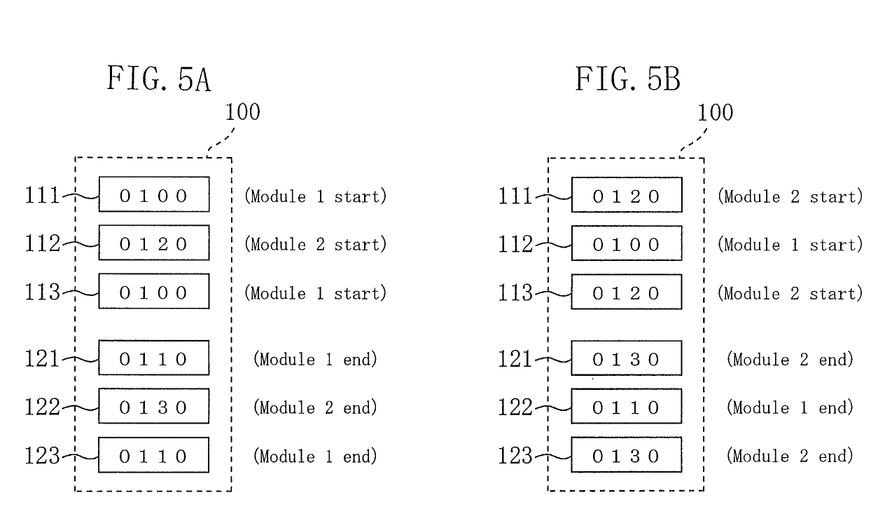

However, when the number of the program modules to be processed is the same as that of the start address storing parts 111 to 113, it is sufficient that the selectors 131 and 132 sequentially select the address storing parts 111 to 113 and 121 to 123 without rewriting the stored content of the address storage device 100 for automatically repeated processing of each program module. When the number of the program modules to be processed is smaller than that of the start address storing parts 111 to 113 (e.g., the number is 2), for example, as shown in FIGS. 5A and 5B, the stored content of the address storage device 100 may be rewritten sequentially in the same manner as in the above-described case where there are four program modules. Alternatively, the read-out selection controller 133 may be reset at the time of executing the last instruction of the program module 2, or the number of stages of the read-out selection controller 133 may be set to two stages.

Alternatively, the supervisory processor 151 or the execution unit 138 can be configured to evaluate the state of each part of the system including the processor so that the start/end addresses in accordance with the evaluation results are stored in the address storing parts 111 to 113 and 121 to 123. This makes it possible to change the order of the processing of the program modules or to allow processing of another program module to be performed in accordance with the states.

As described above, the address storage device 100 stores the start/end address of each program module, and the selection of the start/end address is switched when the current execution instruction address is matched with the end address by hardware (without executing a branching instruction). Thus, processing of the program modules can be sequentially performed without instruction cycles for branching. Therefore, the total processing time can be reduced.

In the above-described example, the address storage device 100 includes three start address storing parts 111 to 113 and three end address storing parts 121 to 123. However, the present invention is not limited thereto, and there is no limitation on the number of the storing part. Even if one storing part is provided, the program module to be processed can be switched without executing a branching instruction by rewriting the start/end address every time processing of each program module ends.

In the above-described example, the program counter 134 stores the relative address. However, the program counter 134 can store the absolute address. More specifically, at the timing when the program counter 134 is reset, the start address (absolute address) output from the selector 131 is preloaded to the program counter 134 so that the output from the program counter 134 is input directly to the program storing part 137. In this case, it is necessary to increase the bit length of the program counter 134, but the adder 135 can be eliminated.

### EXAMPLE 2

A processor of Example 2 of the present invention is as follows. For detection of the end of the processing of each program module, a processing length, a length of each program module, that is, a relative address of the last portion of each program module to the start portion is used instead of the end address, which is an absolute address. In Example 2, elements having the same functions as those in Example 1 have the same reference numerals and will not be described further.

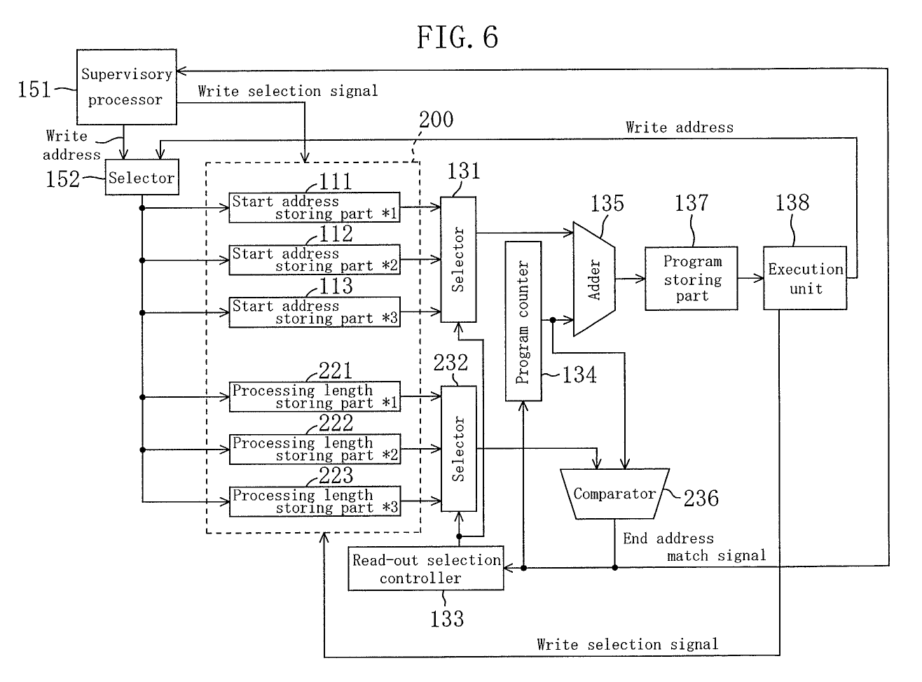

The main difference between the processor of Example 2 and the processor of Example 1 is that, as shown in FIG. 6, an address-processing length storage device 200 including processing length storing parts 221 to 223 (processing length storing means) storing data of a small number of bits is provided instead of the address storage device 100. With this, as a selector 232 (processing length selecting means) and a comparator 236, those with a smaller number of bits than that of Example 1 are used. To the comparator 236, not the current execution instruction address (the absolute address of an instruction to be executed) output from the adder 135, but a value stored in the program counter 134, that is, a relative address from the start portion of the program module is input.

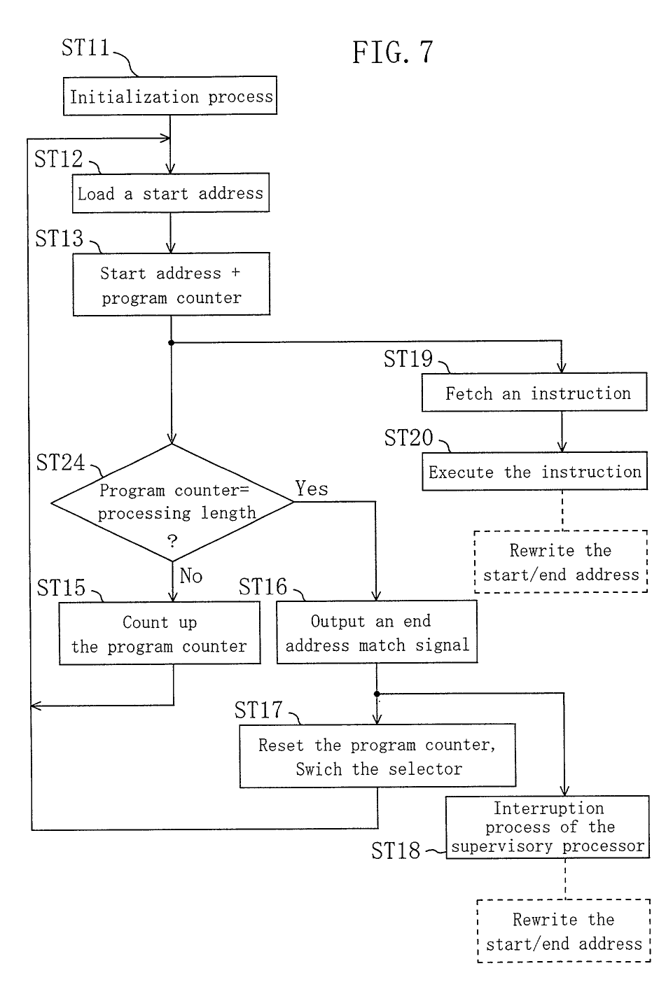

In Example 1 (FIG. 2), the comparator 136 compares the current execution instruction address output from the adder 135 with the end address selected by the selector 132 in the step ST14. On the other hand, the operation of the processor configured as above, as shown in FIG. 7, in a step ST24, the comparator 236 compares the relative address stored in the program counter 134 with the processing length selected by the selector 232. The other operations are the same as those of the steps of Example 1. Therefore, processing of the program modules can be sequentially performed without instruction cycles for branching, so that the total processing time can be reduced. In addition, since the processing length having small amount of data (the number of bits) is used instead of the end address that is an absolute address (read address), a hardware scale for storage of data, selection and comparison can be small.

### EXAMPLE 3

A processor of Example 3 of the present invention is as follows. A buffer for storing a write address output from the supervisory processor 151 is provided so that the supervisory processor 151 can output the write address at an arbitrary timing, that is, in asynchronization with the processing of the program modules.

The processor of Example 3 includes an address storage device 300 that stores a write address output from the supervisory processor 151. More specifically, the address storage device 300 includes start address storing parts 311 to 313 (start address storing means for the supervisory processor) for storing start addresses, and end address storing parts 321 to 323 (end address storing means for the supervisory processor) for storing end addresses corresponding to the start address storing parts 311 to 313, as the address storage device 100. As described with respect to the address storage device 100 in Example 1, the address storage device 300 can be configured with, for example, with a register or can be configured with a memory.

The write addresses output from the address storing parts 311 to 313 and 321 to 323 together with the write address output from the execution unit 138 are input to selectors 331 to 336. More specifically, the write address output from the supervisory processor 151 and the write address output from the execution unit 138 by an execution of a rewrite instruction stored in the program storing part 137 are selected by the selectors 331 to 336. The selectors 331 to 336 are connected to the address storing parts 111 to 113 and 121 to 123.

Furthermore, this processor includes a timing controller 361 for controlling the timing at which addresses stored in the address storing part 311 to 313 and 321 to 323 are written in the addresses storing parts 111 to 113 and 121 to 123. More specifically, when the addresses to be written in the address storing parts 111 to 113 and 121 to 123 are stored in the address storing part 311 to 313 and 321 to 323, this timing controller 361 outputs a write selection signal to the selectors 331 to 336 and the address storage device 100 at the timing at which an end address match signal is output from the comparator 136, that is, at the timing at which writing in the address storing parts 111 to 113 and 121 to 123 is possible. The write selection signal indicates a selection of the address storing parts 311 to 313 and 321 to 323 by the selectors 331 to 336 and a selection of at least one of the address storing parts 111 to 113 and 121 to 123 to write the address in.

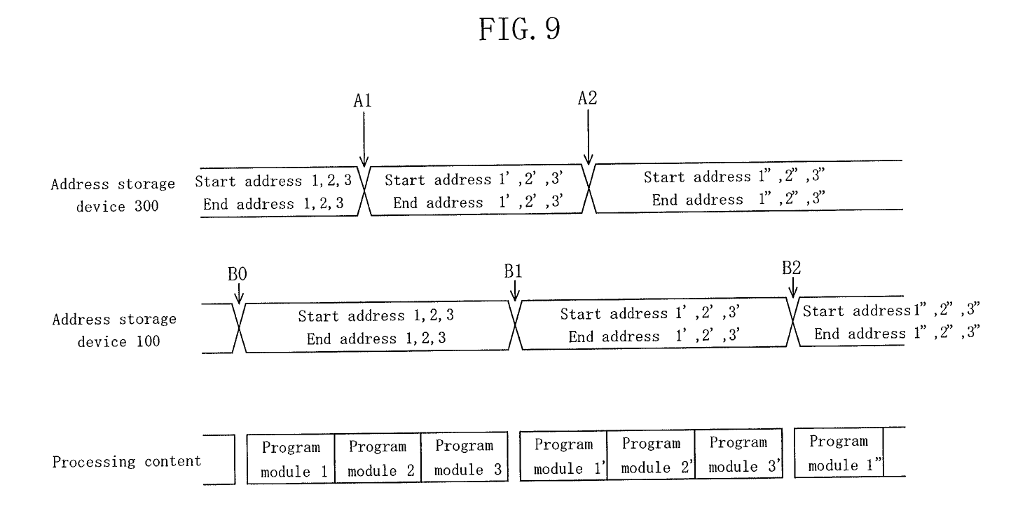

Next, the processor configured as above will be described with reference to FIG. 9. FIG. 9 is a diagram for illustrating the write timing of the start/end address.

Writing the start/end addresses to the address storage device 300 by the supervisory processor 151 is performed at arbitrary timings A1 and A2, regardless of the processing timing of the program modules. In other words, writing addresses to the address storage device 300 does not affect processing of the program modules. Therefore, the supervisory processor 151 is not required to wait for processing of the program module under processing to end, nor perform interruption processing at the time of the end of the processing of the program module. Thus, the supervisory processor 151 can output an address at a timing in accordance with its own processing.

On the other hand, rewriting the start/end addresses stored in the address storage device 300 to the address storage device 100 is performed, for example at timings B0, B1 and B2 at which processing of three program modules ends, by control of the timing controller 361, so that the program modules to be processed sequentially are changed (In FIG. 9, a space is shown every three program modules for convenience, but in reality, there is no waiting time). Rewriting timing is controlled in this manner, so that malfunction, for example, due to a change of the start/end address stored in the end address storing parts 121 to 123 corresponding to the program in processing can be prevented.

As described above, branching control based on the start/end address stored in the address storage device 100 is the same as in Example 1. Therefore, processing of each program module can be performed sequentially without instruction cycles for branching, so that the total processing time can be reduced. In addition, as described above, temporary storage of the address output from the supervisory processor 151 in the address storage device 300 ensures appropriate processing of the program module, and the processing efficiency of the supervisory processor 151 can be improved, for example by eliminating write waiting of the supervisory processor 151.

In the above-described example, the address storage device 300 includes three start address storing parts 311 to 313 and three end address storing parts 321 to 323. However, the number thereof is not limited to three as described with respect to the address storage device 100 in Example 1. The number thereof is not necessarily the same as the address storing parts 111 to 113 and 121 to 123 of the address storage device 100.

In FIG. 9, the start/end address is rewritten for each of the three program modules, but the present invention is not limited thereto. Rewriting can be performed at different timings from program module to program module.

Also in Example 3, the processing length can be used instead of the end address as in Example 2.

A buffer can be provided between the address storage device 100 and the selectors 131 and 132 or between the selectors 131 and 132 and the adder 135/the comparator 136, instead of providing the address storage device 300, as describe above. In this case, if writing an address to the buffer is controlled by the timing controller 361 as in the above-described case, writing to the address storage device 100 can be performed at an arbitrary timing.

### EXAMPLE 4

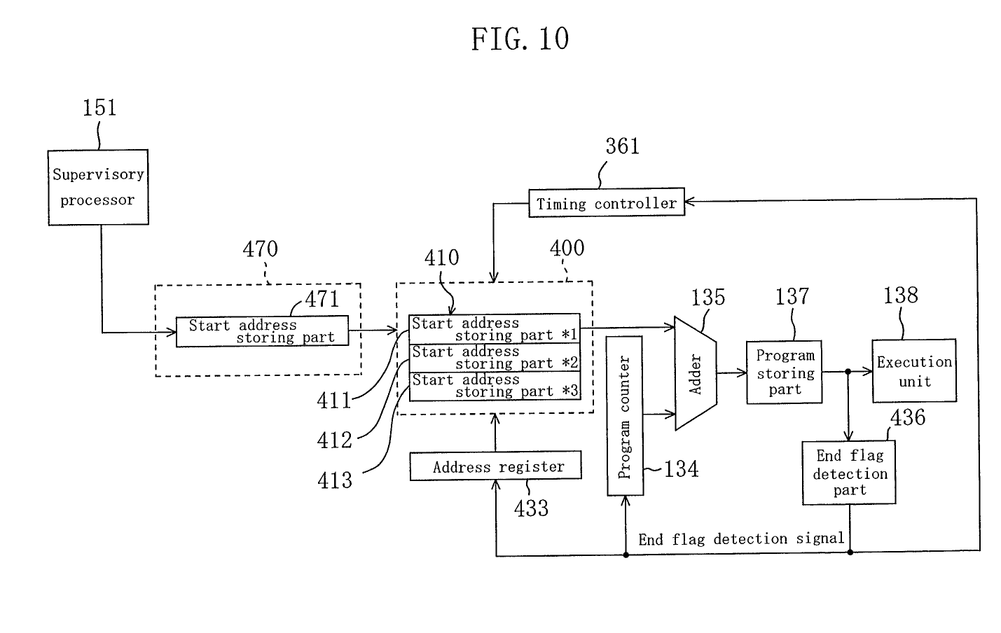

In a processor of Example 4 of the present invention, a memory is used as the address storage device. Moreover, in this processor, an end of processing of a program module is detected by an end flag included in an instruction. Hereinafter, this processor will be described more specifically with reference to FIG. 10.

In FIG. 10, an address storage device 400 includes a memory 410. In the memory 410, a predetermined storage area functions as start address storing parts 411 to 413 for storing the start address of each program module to be processed. The selection of one of the start address storing parts 411 to 413 that stores the start address to be output to the adder 135 is controlled by an address register 433 (address designating means) storing the address of the start address storing parts 411 to 413 that store the start address to be output (The memory 410 also includes the same functions as those of the selectors 131 of Example 1). As a specific example of the address register 433, a counter for sequentially outputting addresses corresponding to the start address storing parts 411 to 413, every time an end flag detection signal is output from the end flag detecting part 436, which will be described later, is used.

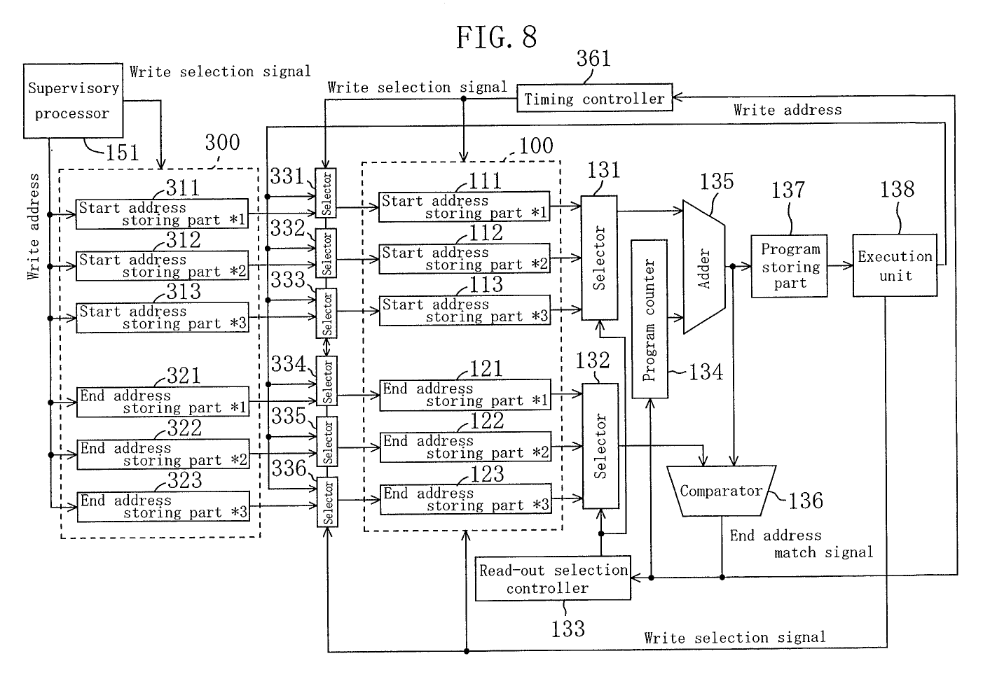

The start address stored in the address storage device 400 can be rewritten by the supervisory processor 151 via an address storage device 470. The address storage device 470 has the same configuration as that of the address storage device 300 of Example 3 (FIG. 8) except that one start address storing part 471 is provided in the address storage device 470, and the start address storing part 471 stores a start address and the address of one of the start address storing parts 411 to 413 to which the start address is to be stored. A plurality of start address storing parts 471 can be provided as in Example 3. However, in this case, since writing to the start address storing parts 411 to 413 cannot be performed at the same time, it is necessary to sequentially write one address at a time. The address storage device 470 can be configured with a memory as in the address storage device 400.

The timing at which the start address is written from the address storage device 470 to the address storage device 400 is controlled by the timing controller 361 as in Example 3. More specifically, in the case where a dual port SRAM, for example, is used as the address storage device 400, it is physically possible to write a new address at the same time when a stored start address is being read. However, as described in Example 1, in order to prevent the start address and the end address of a program module under processing from being rewritten on principle, the timing controller 361 controls the write timing. Therefore, the supervisory processor 151 can write the start address to the address storage device 470 at an arbitrary timing.

A program storing part 137 is similar to that in the processor of Example 1. However, an instruction stored in this program storing part 137 has, in addition to a plurality of bits indicating the content of an instruction, an end flag bit indicating the last instruction of the program module by setting the flag bit (it is not an essential issue whether the bit string including the end flag bit as described above is referred to as an instruction or only the bit string indicating the content of an instruction is referred to as an instruction. In other words, there is no difference in the substantial operation, for example, whether an execution unit 138 fetches the former as an “instruction” and executes the instruction ignoring the end flag bit, or fetches only the latter as an “instruction” and executes the instruction.

An end flag detecting part 436 examines whether or not an end flag bit is set at the time of fetching an instruction from the program storing part 137, and outputs an end flag detection signal to the address register 433, the program counter 134 and the timing controller 361 when it is detected that the end flag bit is set.

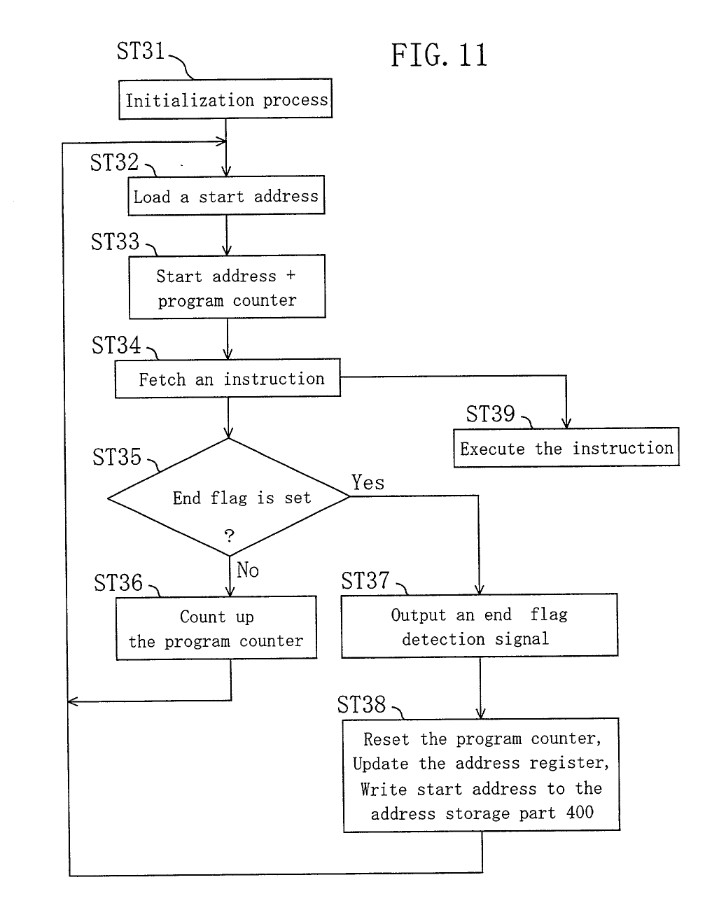

Next, the operation of the processor configured as above will be described with reference to FIG. 11. FIG. 11 is a flowchart showing the operation of the processor.

(Step ST31) First, when processing of the first program module is started, the address storage device 400, the address register 433, and the program counter 134 are initialized, for example, by control of the supervisory processor 151. More specifically, the start address of each program module to be processed sequentially is stored in a predetermined address area of the address storage device 400. The address of the area in which the start address or the end address of the first program module to be processed in the address storage device 400 is preloaded in the address register 433. Furthermore, the program counter 134 is reset to 0.

(Step ST32) The start address stored in an area indicated by address register 433 in the address storage device 400 and the relative address stored in the program counter 134 are loaded in the adder 135.

(Step ST33) The adder 135 adds the loaded start address and the loaded relative address, and outputs an obtained current execution instruction address (absolute address of an instruction to be executed) to the program storing part 137.

(Step ST34) When the current execution instruction address output from the adder 135 is input to the program storing part 137, an instruction stored in the area of that address is fetched by the execution unit 138. Thereafter, the processes after the step ST35 (performed by the end flag detecting part 436 and the like) and the processes after the step ST39 (performed by the execution unit 138) are performed in parallel.

(Step ST35) The end flag detecting part 436 checks whether or not the end flag bit of the instruction fetched by the processor 138 is set.

(Step ST36) When the end flag bit is not set in the step ST35, the program counter 134 is counted up and the processes after the step ST32 are repeated.

(Step ST37) On the other hand, when the end flag bit is set in the step ST35, the end flag detecting part 436 outputs an end flag detection signal to the address register 433, the program counter 134 and the timing controller 361.

(Step ST38) When the end flag detection signal is input to the address register 433, the address register 433 updates the stored address to an address of an area in which the start address of the next program module to be processed is stored. When the end flag detection signal is input to the program counter 134, the program counter 134 is reset to 0. When the address storage device 470 stores a start address to be written in the memory 410, the timing controller 361 instructs the address storage device 400 to capture the start address. Thereafter, the processes after the step ST32 are repeated. Thus, at the time of executing the last instruction of a program module, regardless of the content of the instruction, the selection of the start address storing parts 411 to 413 is automatically switched. Therefore, an instruction cycle for branching is not required, and in the next instruction cycle, the instruction of the next program module can be executed.

(Step ST39) On the other hand, the fetched instruction in the step ST34 is executed by the execution unit 138.

As described above, the end of processing of each program module is detected by the end flag bit, and the selection of the start/end address is switched, so that processing of the program modules can be sequentially performed without an instruction cycle for branching. Thus, the process time can be reduced. Moreover, as in Example 3, temporary storage of the address output from the supervisory processor 151 in the address storage device 470 ensures appropriate processing of the program modules, and the processing efficiency of the supervisory processor 151 can be improved by eliminating write waiting of the supervisory processor 151 or the like. In addition, since the address storage device 400 is required to store only the start addresses so that a hardware scale can be small.

The above-described examples and the elements of variations thereof can be combined.

More specifically, for example, a memory can be used in the address storage devices 100 etc. of Examples 1 to 3 (FIG. 1, 6 and 8) as in the address storage device 400 of Example 4 (FIG. 10). On the contrary, a register can be used in the address storage device 400 of Example 4. Furthermore, a memory can be used for the address storage device 300 of Example 3 or the address storage device 470 of Example 4., instead of the register.

Furthermore, as in Example 3, the address storage device 470 of Example 4 can be provided with a plurality of start address storing parts 471 corresponding to the start address storing parts 411 to 413. When a correspondence relationship between start address storing parts 471 and the start address storing parts 411 to 413 is determined, the start address parts 471 are not necessarily required to store information indicating which one of the start address storing parts 411 to 413 to write the start address in, together with the start address.

In the address storage device 300 as a buffer of Example 3 (FIG. 8), the end address storing parts 321 to 323 can be replaced by processing length storing parts for a supervisory processor (processing length storing means) for storing a processing length, such as the processing length storing parts 221 to 223 of Example 2.

The configuration including an end flag for detecting the last instruction as in Example 4 can be used in the processors of Examples 1 to 3.

The Example 4 can be configured in such a manner that the start address is rewritten not only by the supervisory processor 151, but also by the execution unit 138 executing an instruction, or only by the execution unit 138 executing an instruction. In the other examples, the start address can be rewritten by either one of the supervisory processor 151 and the processor 138. Furthermore, the start address, etc., can be substantially rewritten by another method. In addition, fixed branching processing can be performed at high speed without rewriting. An example of the configuration where the start address, etc., can be rewritten by another method is as follows. The end address of a program module and the start address of the next module or the like are stored in a predetermined region such as a start work area of the program module, and a transfer mechanism for transferring the end address and the like to the start/end address storing parts or the like, for example, during processing of the program module can be provided.

In Example 4, it is possible not to provide the address storage device 470 and the timing controller 361, as in Examples 1 and 3, and the supervisory processor 151 can be configured to control the writing timing of the start address.

Moreover, the following variations are possible.

In the above-described examples, when the read-out selection controller 133 or the address register 433 selects automatically the start address of the next process sequentially when the last instruction is detected. However, the selection can be controlled by the supervisory processor 151 or the execution of an instruction by the execution unit 138. In this case, the processing order of the program modules whose start addresses, etc. are already stored in the address storage device 100 etc. can be changed without changing the stored content in the address storage device 100 etc.

The start address and the end address have been described as absolute addresses, but for example, relative addresses from the address of the last instruction before branching or relative addresses that modify a predetermined base address can be used with no difficulty.

In the above-described examples, a branching destination when the last instruction is detected is uniquely determined. However, the present invention is not limited thereto. A plurality of address storage devices can be provided, and one of the address storage devices can be selected, for example depending on the state such as zero flag. In this manner, as in the case of execution of a conditional branching instruction, the program module to be processed can be varied depending on the results, the state of the equipment or the like. In this case, branching conditions (e.g., a mask indicating which flag of flag registers is set as a branching condition), or the start address of a program module to be processed when the branching condition is met can be stored, for example, in the start portion of the program module.

As described above, branching to the next process can be performed by hardware detecting the last instruction of a process without executing a branching instruction, that is, requiring an instruction cycle of the branching instruction. Therefore, the process that requires branching can be performed at a high speed, so that the total processing time can be reduced. Moreover, a process at a branching destination can be controlled by execution of an instruction or the operation of the supervisory processor, so that processing contents can be changed flexibly in accordance with various conditions.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A processor comprising:
instruction executing means for executing an instruction stored in storing means; and
execution instruction address outputting means for outputting an execution instruction address that is an address of an area in which an instruction to be executed by the instruction executing means is stored;
the processor further comprising:
detecting means for detecting that the instruction to be executed by the instruction executing means is a last instruction of a process before branching,
wherein the execution instruction address outputting means outputs a start address that is an address of an area in the storing means in which a first instruction of a process after branching is stored, when the last instruction is detected by the detecting means.

2. The processor of claim 1,
wherein the execution instruction address outputting means comprising:
start address storing means for storing a start address of each of a plurality of processes in the storing means;
start address selecting means for sequentially switching and selecting the start address stored in the start address storing means, every time the last instruction is detected by the detecting means,
wherein the execution instruction address is output based on the start address selected by the start address selecting means.

3. The processor of claim 1, further comprising:
end address storing means for storing an end address that is an address of an area in which a last instruction of each of a plurality of processes is stored in the storing means;
end address selecting means for sequentially switching and selecting the end address stored in the end address storing means, every time the last instruction is detected by the detecting means,
wherein the detecting means detects the last instruction based on the execution instruction address output from the execution instruction address outputting means and the end address selected by the end address selecting means.

4. The processor of claim 1, further comprising:
processing length storing means for storing a processing length that is a relative address of an end address to a start address of each of a plurality of processes in the storing means;
processing length selecting means for sequentially switching and selecting the processing length stored in the processing length storing means, every time the last instruction is detected by the detecting means,
wherein the execution instruction address outputting means adds a start address of a process under processing and a relative address of the execution instruction address to the start address to generate the execution instruction address, and
the detecting means detects the last instruction based on the relative address and the processing length selected by the processing length selecting means.

5. The processor of claim 1,
wherein the detecting means detects the last instruction based on information indicating the last instruction stored in correspondence with information indicating a content of an instruction to be executed by the instruction executing means in the storing means.

6. The processor of claim 2,
wherein the start address storing means comprises a plurality of registers each of which stores the start address, and
the start address selecting means comprises a selector for selecting one of the plurality of registers.

7. The processor of claim 2,
wherein the start address storing means comprises a memory storing the start address, and
the start address selecting means comprises address designating means for designating an address of an area in which the start address is stored in the memory.

8. The processor of claim 2,
wherein the start address stored in the start address storing means can be set by execution of an instruction by the instruction executing means.

9. The processor of claim 2,
wherein the start address stored in the start address storing means can be set by a supervisory processor for controlling an operation of the processor.

10. The processor of claim 9, further comprising:
start address storing means for the supervisory processor for storing a start address output from the supervisory processor,
wherein the start address stored in the start address storing means for the supervisory processor is written in the start address storing means at a predetermined timing.

11. The processor of claim 3,
wherein the end address storing means comprises a plurality of registers each of which stores the end address, and
the end address selecting means comprises a selector for selecting one of the plurality of registers.

12. The processor of claim 3,
wherein the end address storing means comprises a memory storing the end address, and
the end address selecting means comprises address designating means for designating an address of an area in which the end address is stored in the memory.

13. The processor of claim 3,
wherein the end address stored in the end address storing means can be set by execution of an instruction by the instruction executing means.

14. The processor of claim 3,
wherein the end address stored in the end address storing means can be set by a supervisory processor for controlling an operation of the processor.

15. The processor of claim 14, further comprising:
end address storing means for the supervisory processor for storing an end address output from the supervisory processor,
wherein the end address stored in the end address storing means for the supervisory processor is written in the end address storing means at a predetermined timing.

16. The processor of claim 4,
wherein the processing length storing means comprises a plurality of registers each of which stores the processing length, and
the processing length selecting means comprises a selector for selecting one of the plurality of registers.

17. The processor of claim 4,
wherein the processing length storing means comprises a memory storing the processing length, and
the processing length selecting means comprises address designating means for designating an address of an area in which the processing length is stored in the memory.

18. The processor of claim 4,
wherein the processing length stored in the processing length storing means can be set by execution of an instruction by the instruction executing means.

19. The processor of claim 4,
wherein the processing length stored in the processing length storing means can be set by a supervisory processor for controlling an operation of the processor.

20. The processor of claim 19, further comprising:
processing length storing means for a supervisory processor for storing a processing length output from the supervisory processor,
wherein the processing length stored in the processing length storing means for the supervisory processor is written in the processing length storing means at a predetermined timing.
